(19) United States
(12) Patent Application Publication
(10) Pub. No.: US 2022/0108363 A1
(43) Pub. Date: Apr. 7, 2022

(54) SYSTEM AND METHOD FOR CONTINUOUS MODEL-BASED COST ESTIMATING

(71) Applicants: Hung Viet Nguyen, Berkeley, CA (US); Paul S. Martin, Vacaville, CA (US)

(72) Inventors: Hung Viet Nguyen, Berkeley, CA (US); Paul S. Martin, Vacaville, CA (US)

(21) Appl. No.: 17/499,730

(22) Filed: Oct. 12, 2021

Related U.S. Application Data
(63) Continuation-in-part of application No. 17/187,550, filed on Feb. 26, 2021, now abandoned.
(60) Provisional application No. 62/981,985, filed on Feb. 26, 2020.

(51) Int. Cl. G06Q 30/02

(52) U.S. Cl. CPC G06Q 30/0283

(57) ABSTRACT

A system and method of model-based estimating comprising: receiving a master estimate, including a plurality of master subitem estimates; generating a model estimate, including a plurality of model subitem estimates; generating a subjectives estimate, including a plurality of subjectives subitem estimates; receiving a model update; determining which of said model subitem estimates and said subjectives subitem estimates is impacted by said model update; determining one or more cost updates to said model subitem estimates and said subjectives subitem estimates; updating at least one of said model subitem estimates and said subjectives subitem estimate, based at least in part upon said step of determining one or more cost updates to said model subitem estimates and said subjectives subitem estimates.

### CROSS-REFERENCE TO RELATED APPLICATIONS

This Application claims is a continuation-in-part of prior-filed and copending U.S. patent application Ser. No. 17/187,550, filed Feb. 26, 2021, by Hung Viet Nguyen and Paul S. Martin which claims the benefit of priority to prior-filed U.S. Provisional Patent Application No. 62/981,985, filed Feb. 26, 2020, filed by Hung Viet Nguyen and Paul S. Martin, the compete contents of each of which are hereby incorporated herein by reference.

### BACKGROUND

### Technical Field

The present device relates to the field of estimating and mores specifically to the field of model-based estimating for design and construction.

### Background

The construction industry (and other industries with long duration projects requiring large capital outlays) faces constant risk of cost overruns during design, pre-construction and construction. Progressive owners, design firms and contractors recognize the inefficiencies of conventional project delivery system such as design-bid-build (DBB) and the cost management practices supporting it. Integrated Project Delivery (IPD) methods that include active, continuous estimating with the use of model data are growing in popularity. The continuous estimating approach require a project team to regularly update the estimate and track variances from the last update while design is progressing, that way the project team understand the cost of the current design and can actively steer project costs to established targets. Existing cost estimating systems are not designed to track and make subjective quantities and cost allowance explicit to the project team, therefore, the present device is invented to create an estimating system that better support model-based and continuous estimating.

With recent developments in design support technology coupling with innovative construction materials, forms and shapes of construction facilities are becoming more and more complex. Traditional methods of doing quantity takeoff based on two-dimensional drawings are proved to be error-prone and inefficient in dealing with complex designs. Recent development of Building Information Modeling (BIM) offers estimators advanced tools for quantity takeoff and estimating.

BIM and associated technologies are quickly becoming the next step in the evolution of the estimating process. The estimating community is discovering how estimators work in a collaborative atmosphere with modeling team. Because of the need to stay competitive in the industry, it is essential that this new technology is utilized to its fullest potential by the estimators. BIM allows estimators to be faster and leaner while increasing quality. This evolving technology offers the estimator a “real-time” conduit to a project's development of design and function and the associated cost impacts through the entire design process.

Estimators, for the most part, have a strong protective attitude when it comes to preparing pricing. They price what they know and discover what they don't know. They put the estimate together with the confident conclusion of an accurate forecast of what a project will cost. Estimators can passionately defend their estimates from tough scrutiny because the estimator knows their estimate very well. They understand the relevant cost drivers, the required subjective line items which include individuality and style as the result of the interpretation of the data (or lack of data). In essence the estimator understands their estimate because of the personal interaction in creating it. If the model is to be considered a trusted estimating resource it will require the estimator to understand the data points and cost drivers that make up the model to the same comprehension as the traditional detailed construction estimate. Existing BIM-based estimating solutions did not address this fundamental need and therefore has not gained trust and popularity by estimators.

Especially, existing solutions rely mainly on the quantities extracted from BIM and do not account for scopes that not yet included or only partially included or will never be included in BIM. These will be refer to as “subjective” quantities and cost allowance in this patent. During design and pre-construction phase these subjectives may change significantly between design versions and impact cost estimates of that design version. Existing BIM based estimating solutions fail to identify, track and make the subjective quantities and cost allowance explicit to the estimators and therefore fail to get trust and popular adoption from estimators. What is needed are systems and methods to make model-based estimating processes and results reliable by incorporating a systemic method to track subjective quantities and its assumptions alongside with BIM-based quantities.

### BRIEF DESCRIPTION OF THE DRAWINGS

Further details of the present device are explained with the help of the attached drawings in which:

FIG. 1a depicts an overview of a system for creating and updating an estimate.

FIG. 1b depicts a high-level overview of the inter-relation/correlation of Model/objectives to Subjectives during design/construction progression.

FIG. 2a depicts an embodiment of a function block diagram of the method for creating and updating an estimate.

FIG. 2b depicts an embodiment of a function block diagram of the method for creating and updating an estimate.

FIG. 3 depicts a computer system on which the systems and methods described herein can be implemented.

FIG. 4 depicts an exemplary embodiment of a system and method for model-based estimating.

FIG. 5a depicts an embodiment of a system 500 for creating and updating a cost estimate.

FIG. 5b-i depict a flow chart for an embodiments of the present system and method for creating an estimate.

FIG. 6 depicts a schematic block diagram of an embodiment of the present system.

FIGS. 7a-c depict a detail schematic block diagram of an embodiment of the present system.

FIGS. 8a and 8b depict a detail schematic block diagram of an embodiment of an estimating module of the present system.

### DETAILED DESCRIPTION

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

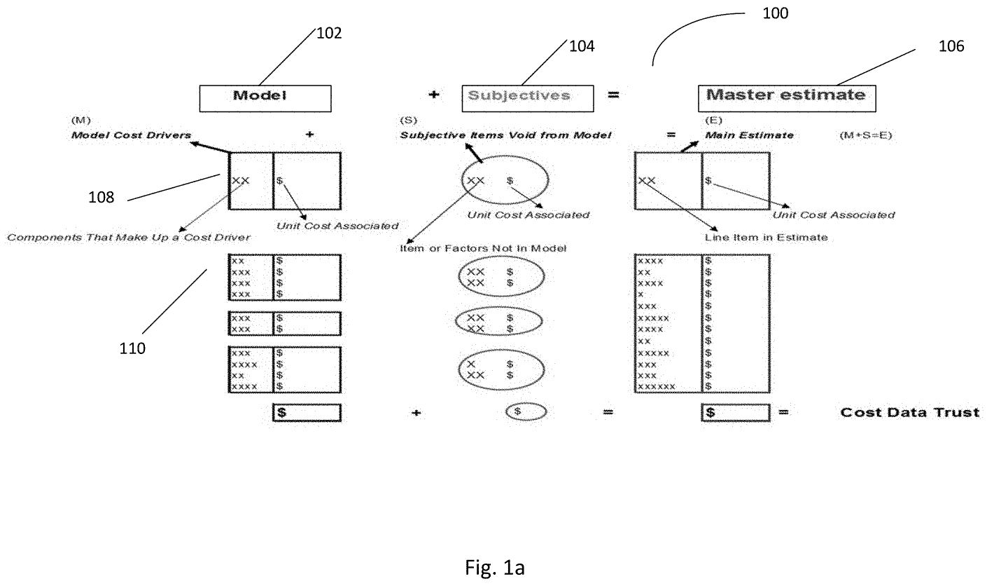

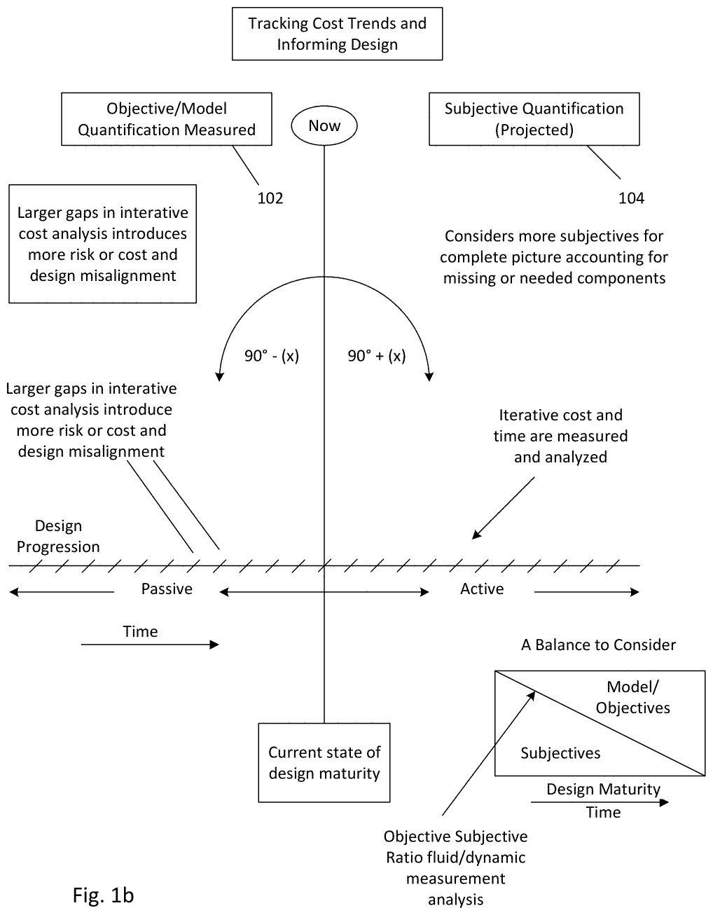

FIG. 1a depicts an overview of a system for creating and updating an estimate 100. In FIG. 1a three categories can be used to understand the maturity level of a cost model-Model 102, Subjectives 104, and Master Estimate 106. The system 100 is considered to be in a trusted state when the following formula is true:

Total cost in the Model (102)+Total cost in the Subjectives (104)=Total cost in the Master Estimate (106)

In some embodiments, the model 102 can be comprised of a tremendous amount of model data. Moreover, some of the model data can be relevant to cost and some may not. Moreover, the data can be interrelated and/or corelated as some data or data changes can impact other data. By way of non-limiting example, the cubic yardage of concrete in the model can be interrelated or corelated with the quantity of rebar. In some embodiments, model data that is pertinent to cost can be grouped logically together in cost driver groups 108 comprised of individual cost drivers 110. Cost drivers 110 are parameters that can have a substantial or evident impact on an overall system cost (or the master estimate 106). By way of non-limiting example, the square footage of stone panel can be a cost driver 110 for an exterior stone system. In creation of the master estimate 106, the estimation of cost from the model 102 to master estimate 106 can focus on the cost drivers, not the miscellaneous items. Again by way of non-limiting example, costs of materials in the overall estimate (such as brackets, bolts . . . which are miscellaneous items and are not modeled or partially modeled in the model 102 versus stone panels which are modeled in the model 102) and costs of installation (labor, equipment) will be allocated as required to allow for accurate production cost estimate versus material cost estimate of stone panel in the model. Thus, in some embodiments, the items in cost driver 110 groups can be relevant parameters that are required for the product and/or system being estimated. However, in alternate embodiments, the model 102 can include model cost drivers 108 that have a less substantial impact on the overall estimate too. That is, the overall system 100 can accommodate any known, convenient and/or desired level or granularity relative to individual cost drivers 110 and/or cost driver groups 108.

The Subjectives 104 are cost items that may be captured in the master estimate but are not yet in the mode 102 or will never be included in the model 102. The subjective cost is the bridge between model cost and Estimated cost. In the system 100 presented herein, data fields to capture subjective quantity and/or cost are added and can be tracked as the model progresses during design and construction.

The Master Estimate 106 includes all costs for a project and represents the baseline cost estimate. It can be used to validate the model 102 and to determine the models trust factor and reliability to the actual construction cost.

In some embodiments, each individual cost line item if in the Model 102 and Subjectives 104 can be accounted for in the Master Estimate. Conversely in some embodiments every cost line item in the Master Estimate 106 can be accounted for in either the Model 102 and/or in the Subjectives 104.

In operation, the Model 102 transformation to an “actual cost” model can be a methodical and planned movement. Data points, cost driver groups 108, cost drivers 110 and interrelations/correlations therebetween that make up the Model 102 should be fully understood by the estimator to allow for conformation that the Model 102 is in sync or substantially in sync and is approaching the same quality and expectations as the trusted Master Estimate 106.

As depicted in FIG. 1a, the balance of Subjective 104 to Model (or Objective) 102 data ratio can be used as an indicator for model maturity and estimate reliability. Tracking the trajectory of Subjective 104 to Model 102 data ratio as well as assumptions used for estimating Subjective 104 is important for mitigating and analyzing reliability of the Master estimate 106.

Upon receipt of a change to the project the Model 102 (either during construction and/or during the design phase) can be updated (for quantity or cost) by identifying those cost driver groups 108 and/or cost drivers that may be impacted by the change as well as any interrelated/correlated cost driver groups 108 and/or cost drivers 110, which can also be updated. Subjectives related to the impacted cost driver groups 108 and/or cost drivers 110 can then be updated in response to the changes to the Model 102.

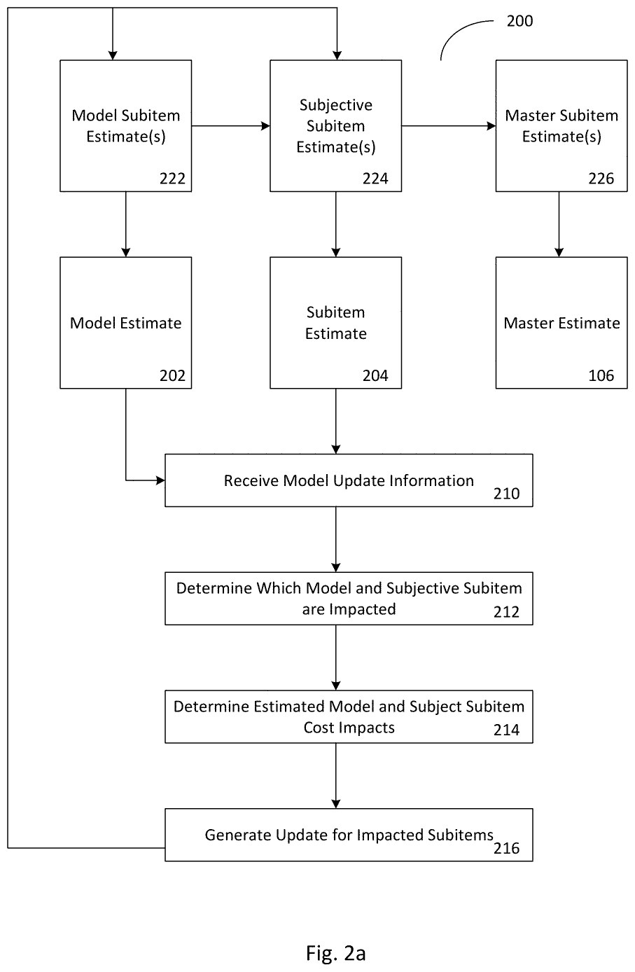

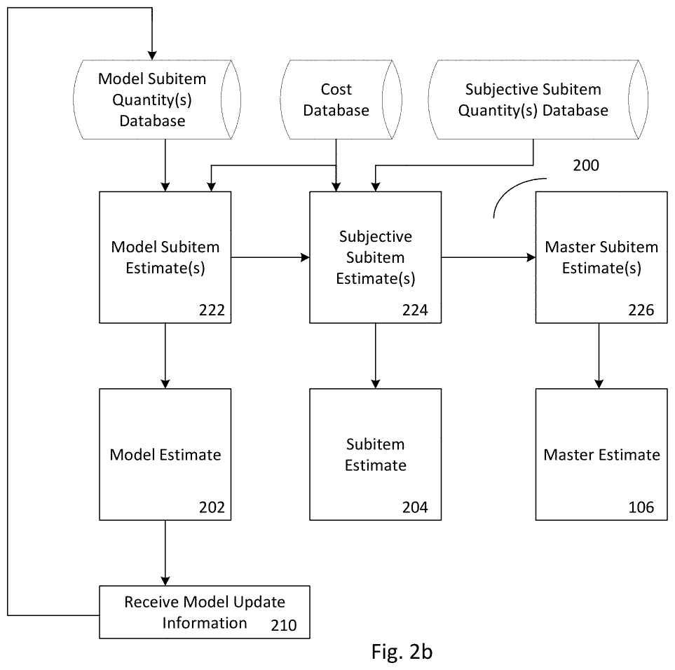

FIGS. 2a and 2b depict function block diagrams of embodiments of methods for creating and updating an estimate 200. As depicted in FIG. 2a, in step 202 a Model Estimate is created from the Model 102 and in step 204, a Subjectives Estimate is created from the Subjectives 104. In operation, the Master Estimate 106 should be equal to or substantially similar to the summation of the Model Estimate 202 and the Subjectives Estimate 204. Moreover, the Model Estimate 202 can be comprised of subitems or sub-groups contained within Model Subitems Estimate(s) 222, the Subjectives Estimate 104 can be comprised of subitems or sub-groups contained within Subjectives Subitem Estimate(s) 224 and the Master Estimate 106 can be comprised of subitems or sub-groups contained within Master Subitem Estimate(s) 226.

In step 210 Model update information can be received and then in step 212 it is determined which Model and Subjective subitem(s)/sub-group(s) are impacted by the Model update information. Estimates for cost impacts to the identified Model and Subjective subitem(s)/sub-group(s) can then be determined in step 214 and updates for the Model subitem(s)/sub-group(s) 222 and/or Subjectives subitem(s)/sub-group(s) 224 can be generated in step 216. Such updates generated in step 216 can then be passed to the related Model subitem(s)/sub-group(s) 222 and/or Subjectives subitem(s)/sub-group(s) 224. These updates can also update the Master subitem(s)/sub-group(s) 226, the Model Estimate 202, the Subjectives Estimate 204 and thus the overall Master Estimate 106.

FIG. 2b depicts an alternate embodiment of a function block diagram of the method for creating and updating an estimate.

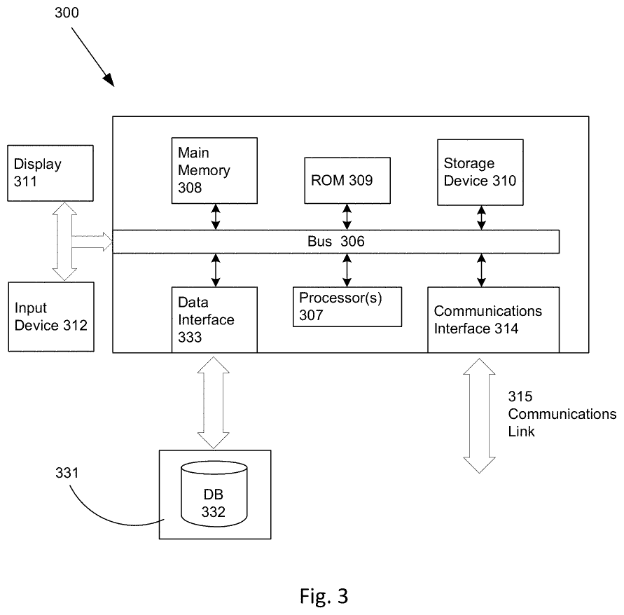

The execution of the sequences of instructions required to practice the embodiments can be performed by a computer system 300 as shown in FIG. 3. In an embodiment, execution of the sequences of instructions is performed by a single computer system 300. According to other embodiments, two or more computer systems 300 coupled by a communication link 315 can perform the sequence of instructions in coordination with one another. Although a description of only one computer system 300 will be presented below, however, it should be understood that any number of computer systems 300 can be employed to practice the embodiments.

A computer system 300 according to an embodiment will now be described with reference to FIG. 3, which is a block diagram of the functional components of a computer system 300. As used herein, the term computer system 300 is broadly used to describe any computing device that can store and independently run one or more programs.

Each computer system 300 can include a communication interface 314 coupled to the bus 306. The communication interface 314 provides two-way communication between computer systems 300. The communication interface 314 of a respective computer system 300 transmits and receives electrical, electromagnetic or optical signals, that include data streams representing various types of signal information, e.g., instructions, messages and data. A communication link 315 links one computer system 300 with another computer system 300. For example, the communication link 315 can be a LAN, in which case the communication interface 314 can be a LAN card, or the communication link 315 can be a PSTN, in which case the communication interface 314 can be an integrated services digital network (ISDN) card or a modem, or the communication link 315 can be the Internet, in which case the communication interface 314 can be a dial-up, cable or wireless modem.

A computer system 300 can transmit and receive messages, data, and instructions, including program, i.e., application, code, through its respective communication link 315 and communication interface 314. Received program code can be executed by the respective processor(s) 307 as it is received, and/or stored in the storage device 310, or other associated non-volatile media, for later execution.

In an embodiment, the computer system 300 operates in conjunction with a data storage system 331, e.g., a data storage system 331 that contains a database 332 that is readily accessible by the computer system 300. The computer system 300 communicates with the data storage system 331 through a data interface 333. A data interface 333, which is coupled to the bus 306, transmits and receives electrical, electromagnetic or optical signals, that include data streams representing various types of signal information, e.g., instructions, messages and data. In embodiments, the functions of the data interface 333 can be performed by the communication interface 314.

Computer system 300 includes a bus 306 or other communication mechanism for communicating instructions, messages and data, collectively, information, and one or more processors 307 coupled with the bus 306 for processing information. Computer system 300 also includes a main memory 308, such as a random access memory (RAM) or other dynamic storage device, coupled to the bus 306 for storing dynamic data and instructions to be executed by the processor(s) 307. The main memory 308 also can be used for storing temporary data, i.e., variables, or other intermediate information during execution of instructions by the processor(s) 307.

The computer system 300 can further include a read only memory (ROM) 309 or other static storage device coupled to the bus 306 for storing static data and instructions for the processor(s) 307. A storage device 310, such as a magnetic disk or optical disk, can also be provided and coupled to the bus 306 for storing data and instructions for the processor(s) 307.

A computer system 300 can be coupled via the bus 306 to a display device 311, such as, but not limited to, a cathode ray tube (CRT) or a liquid-crystal display (LCD) monitor, for displaying information to a user. An input device 312, e.g., alphanumeric and other keys, is coupled to the bus 306 for communicating information and command selections to the processor(s) 307.

According to one embodiment, an individual computer system 300 performs specific operations by their respective processor(s) 307 executing one or more sequences of one or more instructions contained in the main memory 308. Such instructions can be read into the main memory 308 from another computer-usable medium, such as the ROM 309 or the storage device 310. Execution of the sequences of instructions contained in the main memory 308 causes the processor(s) 307 to perform the processes described herein. In alternative embodiments, hard-wired circuitry can be used in place of or in combination with software instructions. Thus, embodiments are not limited to any specific combination of hardware circuitry and/or software.

The term “computer-usable medium,” as used herein, refers to any medium that provides information or is usable by the processor(s) 307. Such a medium can take many forms, including, but not limited to, non-volatile, volatile and transmission media. Non-volatile media, i.e., media that can retain information in the absence of power, includes the ROM 309, CD ROM, magnetic tape, and magnetic discs. Volatile media, i.e., media that can not retain information in the absence of power, includes the main memory 308. Transmission media includes coaxial cables, copper wire and fiber optics, including the wires that comprise the bus 306. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes can be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention can be implemented in a variety of computer systems. The various techniques described herein can be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high-level procedural or object-oriented programming language to communicate with a computer system. However, the programs can be implemented in assembly or machine language, if desired. In any case, the language can be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system can also be considered to be implemented as a computer-readable storage medium, configured with a computer program, where the storage medium so configured causes a computer to operate in a specific and predefined manner. Further, the storage elements of the exemplary computing applications can be relational or sequential (flat file) type computing databases that are capable of storing data in various combinations and configurations.

A storage device may also store instructions, instructions, such as source code or binary code, for performing the techniques described above. A storage device may additionally store data used and manipulated by the computer processor.

A memory or storage device may be an example of a non-transitory computer-readable storage medium for use by or in connection with the video encoder and/or decoder. The non-transitory computer-readable storage medium contains instructions for controlling a computer system to be configured to perform functions described by particular embodiments. The instructions, when executed by one or more computer processors, may be configured to perform that which is described in particular embodiments.

Also, it is noted that some embodiments have been described as a process which can be depicted as a flow diagram or block diagram. Although each may describe the operations as a sequential process, many of the operations can be performed in parallel or concurrently. In addition, the order of the operations may be rearranged. A process may have additional steps not included in the figures.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be configured to perform that which is described in particular embodiments.

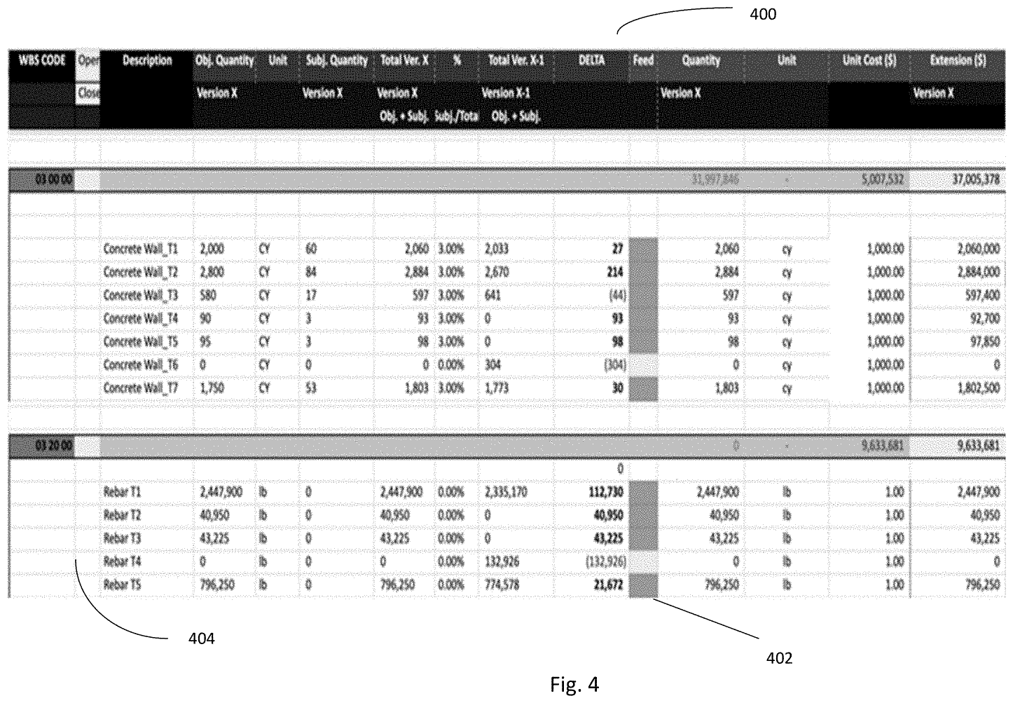

FIG. 4 depicts an exemplary embodiment 400 of a system and method for model-based estimating. In the embodiment depicted in FIG. 4, indicia can be employed to indicate when and how a given line item 404 has been updated and/or derived. By way of non-limiting example, in some embodiments first indicia can be used to indicate that the line item 404 is based on the model, second indicia can be used to indicate that the line item 404 has been updated in an automated manner but does not require additional review as the update was within prescribed boundaries and third indicia can be used to indicate that the line item 404 has been updated and requires review. In some embodiments more than three classification of indicia can be employed. Moreover, in some embodiments the indicia can be colors, characters and/or any other known convenient and/or desired visual and/or, in some embodiments, audible or other sensory indicators.

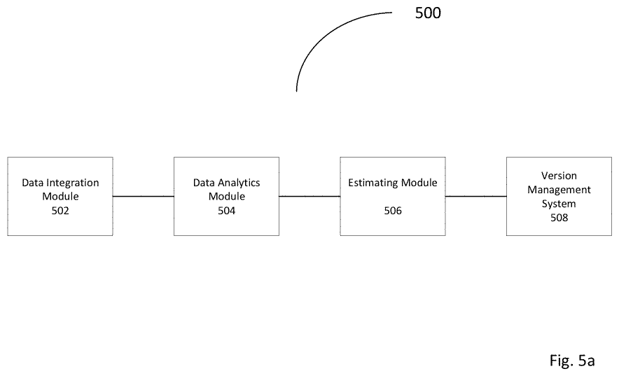

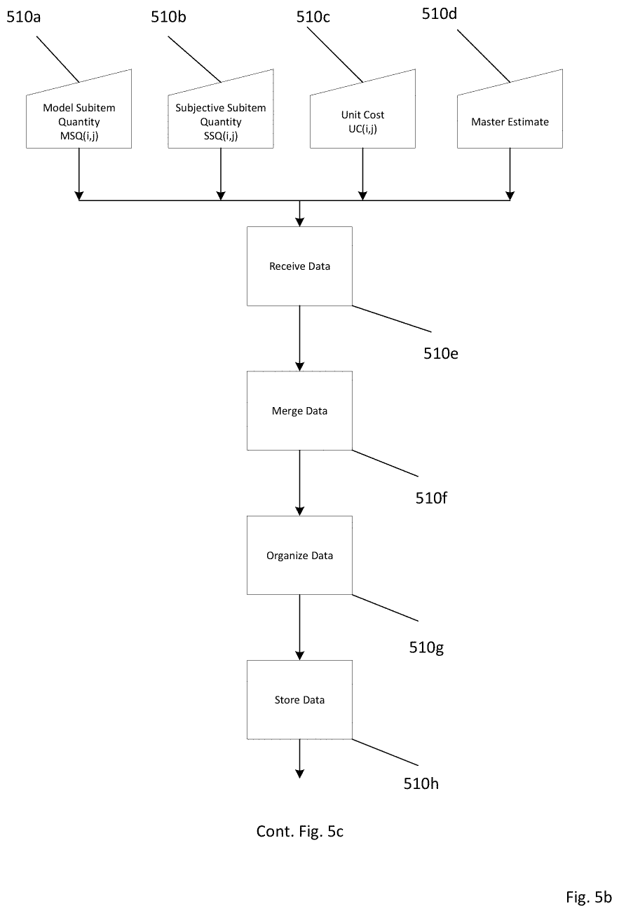

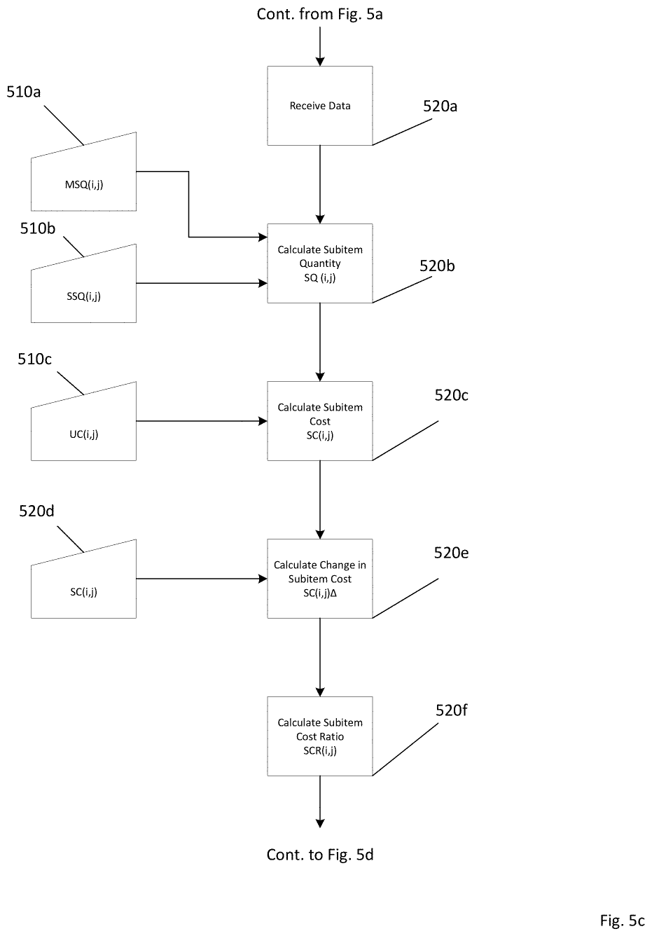

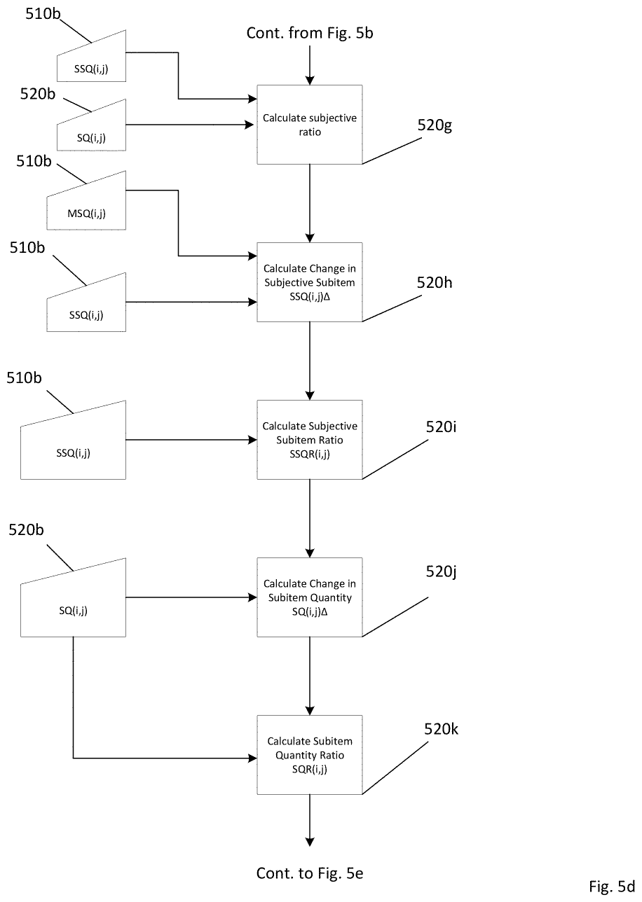

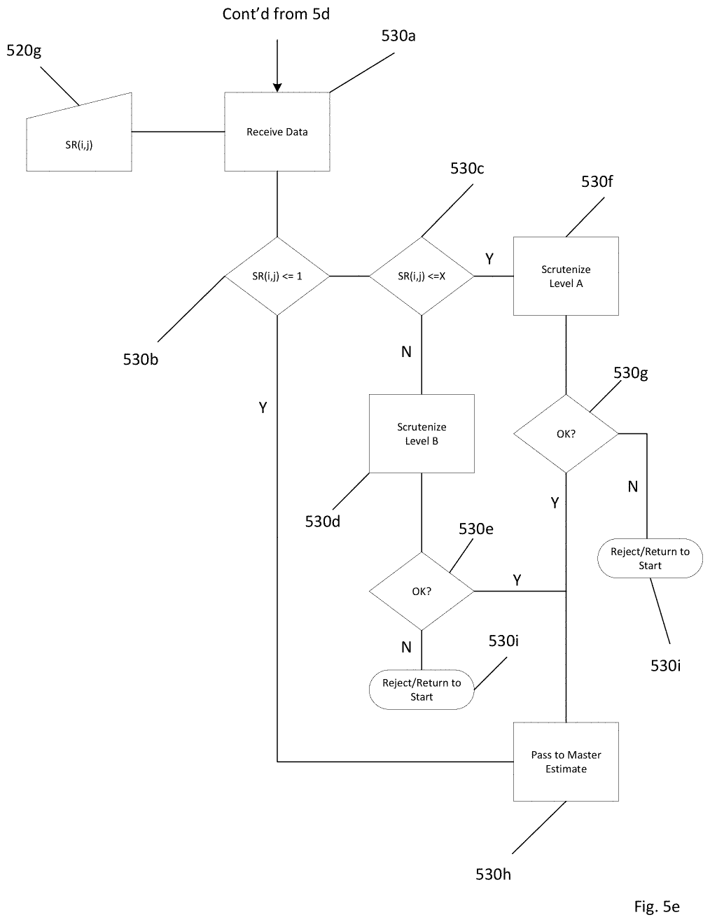

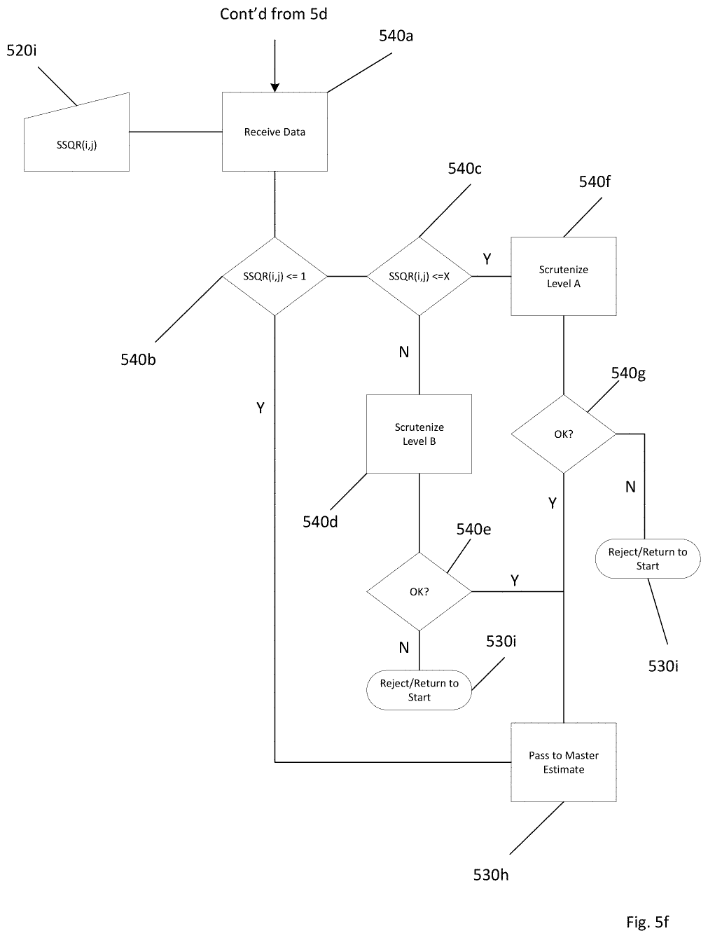

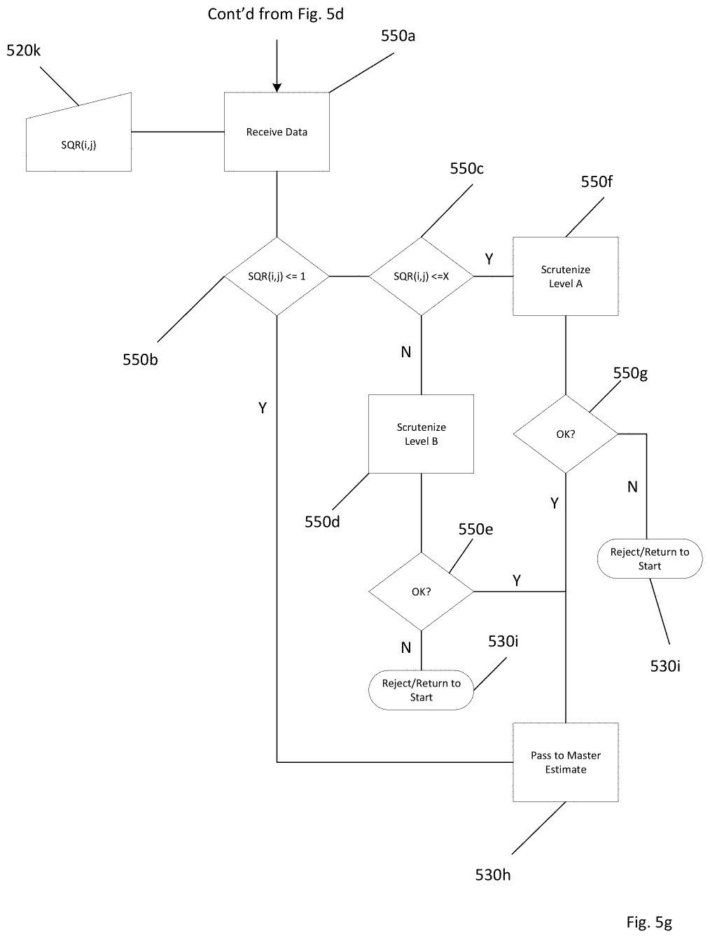

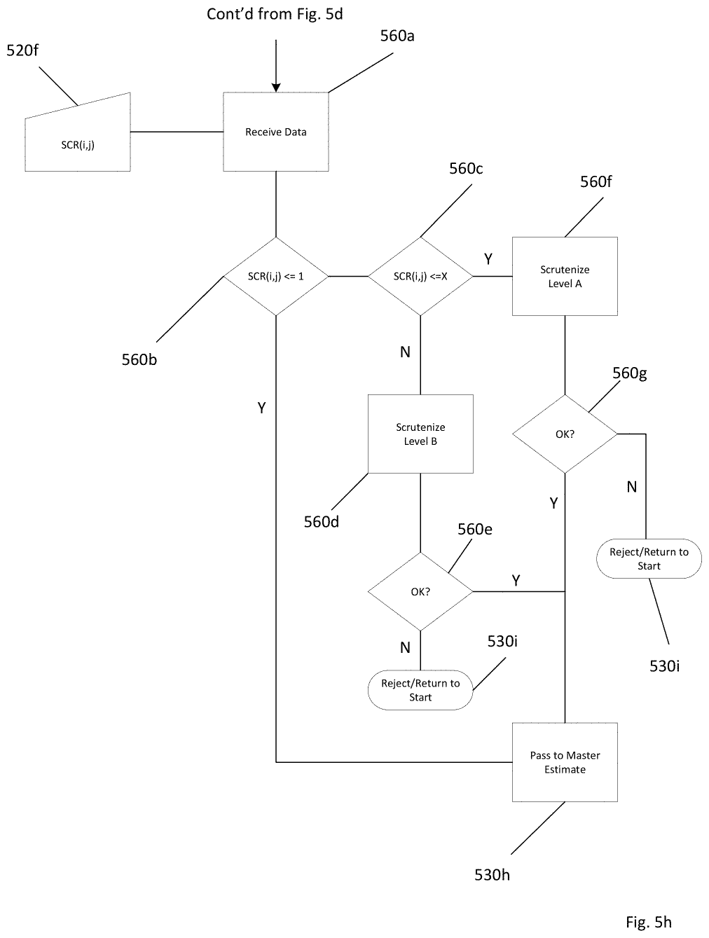

FIGS. 5a-5i depict an embodiment of a system 500 for creating and updating a cost estimate. As shown in FIG. 5a, a system 500 can comprise a data integration module 502, a data analytics module 504, an estimating module 506 and a version management system 508.

FIG. 5b depicts a detailed flow chart of a data integration module 502. A Work Breakdown Structure (WBS) can be a hierarchical decomposition of the total scope of work to be carried out by the project team to accomplish the project objectives and create the required deliverables. MasterFormat, UniFormat, and Uniclass are some examples of commonly used WBS. A WBS can have a numbering system for organizing project data such as quantity, cost, schedule or BIM model objects belonging to a specific scope of work.

As shown in FIG. 5b, a data integration module 502 can receive Model Subitem Quantity (MSQij) 510a, Subjective Subitem Quantity (SSQij) 510b, Unit Cost (UCij) 510c, and Master Estimate 510d data 510e. In some embodiments, these data can be input by a user, other system, or any other known and/or convenient entity, but in other embodiments can be provided or received in response to a signal or input. A data integration module 502 can merge this data 510f and organize this data 510g. A data integration module 502 can store this data 510h.

In some embodiments, i can be the index (number) of items in an WBS. In some embodiments, j is the index (number) of an estimate version. Model Subitem Quantity (MSQij) data 510a are the quantity of item i extracted from a design and/or construction building information model. MSQij data 510a is organized by a WBS and can be used to inform an estimate version j.

The Subjective Subitem Quantity (SSQij) data 510b are the quantities that are not yet included or will never be included in the BIM. The subjective can be the bridge between BIM and the complete quantity needed for cost estimating. In the system 500 presented herein, data fields to capture subjective quantity and/or cost are added and can be tracked as the model progresses during design and construction. SSQij data 510b can be organized by a WBS used to inform an estimate version j

FIGS. 5c and 5d depict a flowchart of a data analytics module 504. A data analytics module 504 can receive data from a data integration module 502. As shown in FIG. 5c, data analytics module 504 can determine Subitem Quantity (SQij) 520b according to the formula: SQij=MSQij+SSQij, as shown in FIG. 5c. A data analytics module 504 can determine subitem cost (SCij) 520c according to the formula: UCij*SQij. A data analytics module 504 can determine the change in subitem cost (SCijΔ) according to the formula: SCijΔ=SCij−SCij₋₁, and the Subitem Cost Ratio (SCRij) 520e according to the formula: 100*(SCijΔ/SCij).

As shown in FIG. 5d, a data analytics module 504 can determine Subjective Ratio (SRij) 520g according to the formula SRij=100*SSQij/SQij. A data analytic module 504 can determine the change in Subjective Subitem Quantity (SSQijΔ) 520h according to the formula: SSQijΔ=SSQij−SSQij₋₁; and the Subjective Subitem Quantity Ratio (SSQRij) 520i according to the formula: 100*SSQijΔ/SSQij.

As shown in FIG. 5d, a data analytics module 504 can determine the change in subitem quantity (SQijΔ) 520j according to the formula SQijΔ=SQij−SQij₋₁. A data analytics module 504 can determine the subitem quantity ratio (SQRij) 520k according to the formula: SQRij=100*(SQijΔ/SQij). However, in some embodiments, alternate formulations can be used to determine a subitem quantity ratio (SQRij). A data analytic module 504 can determine the change in Subjective Subitem Quantity (SSQijΔ) 520h according to the formula: SSQijΔ=SSQij−SSQij₋₁; and the Subjective Subitem Quantity Ratio (SSQRij) 520i according to the formula: 100*(SSQijΔ/SSQij). However, in some embodiments, alternate formulations can be used to determine Subjective Subitem Quantity (SSQijΔ) and/or Subjective Subitem Quantity Ratio (SSQRij).

FIGS. 5e-5h depict a flowchart for an estimating module 506. As shown in FIG. 5e, an estimating module 506 can receive 530a value for Subjective Ratio (SRij) 520g and determine the level of scrutiny that it should incur. If SRij 520g is less than or equal to one 530b, then the data can be accepted into the master estimate 510d without further scrutiny 530h. If not, then an estimating module 506 can determine if SRij 520g is less than or equal to a predetermined quantity x 530c. If so, then the data can be subjected to a predetermined first level of scrutiny 530f and it can be determined whether or not if SRij 520g is satisfactory. If not, then the data can be subjected to a predetermined second level of scrutiny 530d and it can be determined whether or not if SRij 520g is satisfactory. In either case, if said ratios are determined to be satisfactory, then an estimating module 506 can accept data 530h into a master estimate 510d. If not, then data cannot be accepted into a master estimate 510d, and the changes are rejected and the user is returned to the start 530i

As shown in FIG. 5f, an estimating module 506 can receive a value for Subjective Subitem Quantity Ratio (SSQRij) 520i and determine the level of scrutiny that it should incur. If SSQRij 520i is less than or equal to one, then the data can be accepted into the master estimate 510d without further scrutiny. If not, then an estimating module 506 can determine if SSQRij 520i is less than or equal to a predetermined quantity x. If so, then the data can be subjected to a predetermined first level of scrutiny and it can be determined whether or not if SSQRij 520i is satisfactory. If not, then the data can be subjected to a predetermined second level of scrutiny and it can be determined whether or not if SSQRij 520i is satisfactory. In either case, if said ratios are determined to be satisfactory, then an estimating module 506 can accept data into a master estimate 510d. If not, then data cannot be accepted into a master estimate 510d.

As shown in FIG. 5g, an estimating module 506 can receive a value for Subitem Quantity Ratio (SQRij) 520k and determine the level of scrutiny that it should incur. If SQRij 520k is less than or equal to one 550b, then the data can be accepted 530h into the master estimate 510d without further scrutiny. If not, then an estimating module 506 can determine if SQRij 520k is less than or equal to a predetermined quantity x 550c. If so, then the data can be subjected to a predetermined first level of scrutiny and it can be determined whether or not if SQRij 520f is satisfactory. If not, then the data can be subjected to a predetermined second level of scrutiny 550d and it can be determined whether or not if SQRij 520k is satisfactory. In either case, if said ratios are determined to be satisfactory, then an estimating module 506 can accept data 530h into a master estimate 510d. If not, then data cannot be accepted into a master estimate 510d and the changes are rejected and a user can be directed to the start of the process 530i.

As shown in FIG. 5h, an estimating module 506 can receive a value for Subjective Cost Ratio (SCRij) 520f and determine the level of scrutiny that it should incur. If SCRij 520c is less than or equal to one 560b, then the data can be accepted 530h into the master estimate 510d without further scrutiny. If not, then an estimating module 506 can determine if SCRij 520c is less than or equal to a predetermined quantity x 560c. If so, then the data can be subjected to a predetermined first level of scrutiny 560f and it can be determined whether or not if SCRij 520f is satisfactory. If not, then the data can be subjected to a predetermined second level of scrutiny and it can be determined whether or not if SRij 520g is satisfactory. In either case, if said ratios are determined to be satisfactory, then an estimating module 506 can accept data 530h into a master estimate 510d. If not, then data cannot be accepted into a master estimate 510d

FIG. 5i depicts a flow chart of a version management system 508. A version management system 508 can receive data Model Subitem Quantity (MSQij) 510a, Subjective Subitem Quantity (SSQij) 510b, and Subitem Quantity (SQij) 520b. If the conditions for the ratio data are satisfied, as described above in an estimating module 506, then a version management system 508 can accept this data for a master estimate 510d and the changes are rejected and a user can be directed to the start of the process 530i.

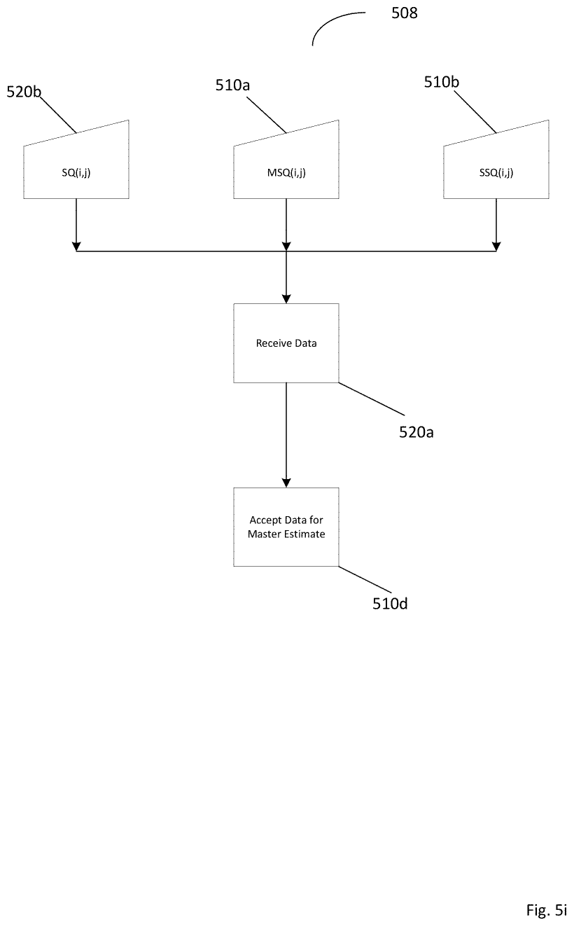

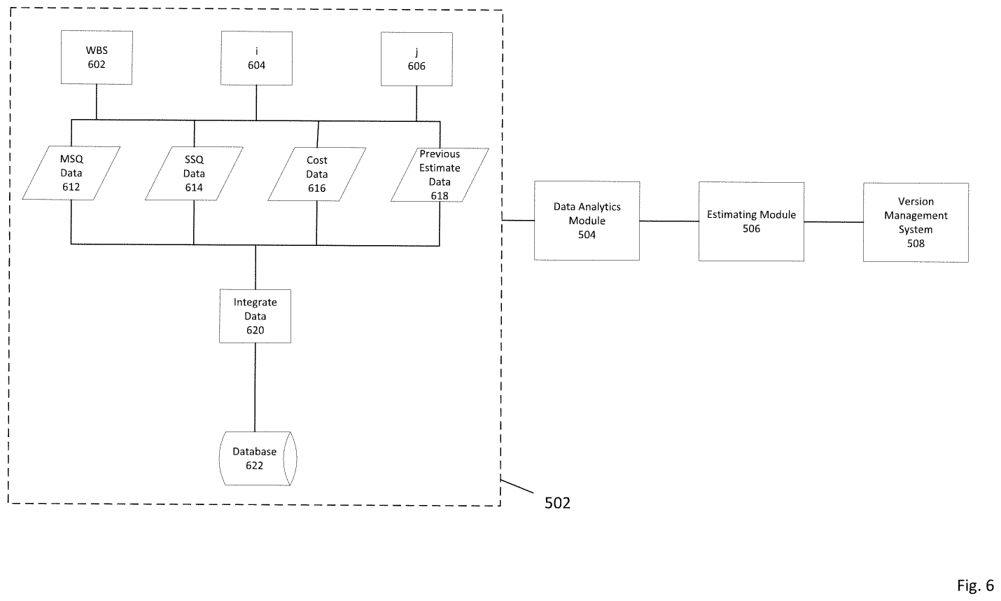

FIG. 6 depicts a detail block diagram of an embodiment of the present system. In some embodiments, a data integration module 502 can further comprise a Work Breakdown Structure (WBS) 602. In some embodiments, i 604 can be the index (number) of items in an WBS. In some embodiments, j 606 can be the index (number) of an estimate version. As shown in FIG. 6, a data integration module 502 can further comprise Model Subitem Quantity (MSQ) data 612, Subjective Subitem Quantity (SSQ) data 614, Cost data (UC) 616, and Previous Estimate data 618. A data integration module 502 can integrate data and store said data in a database 622.

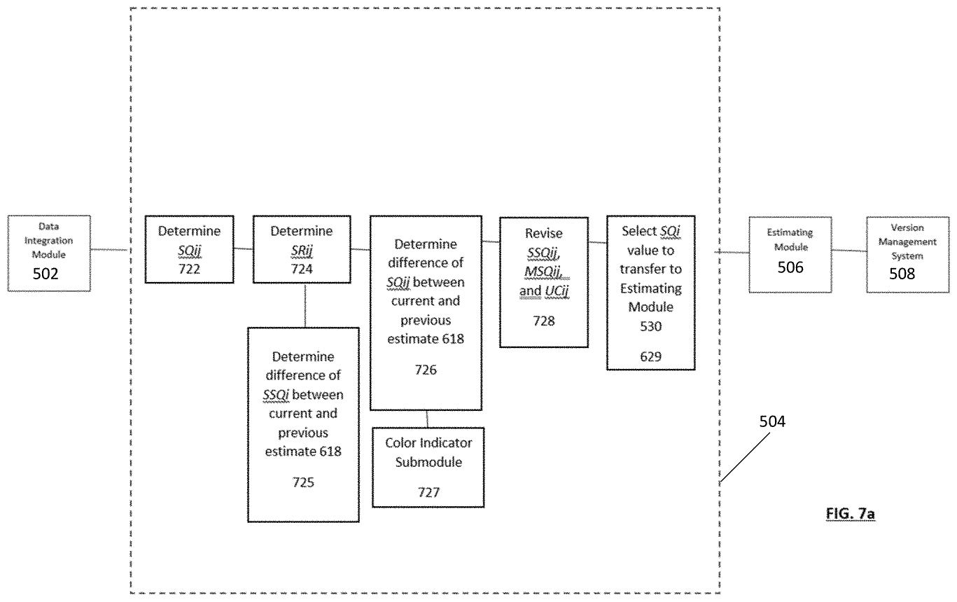

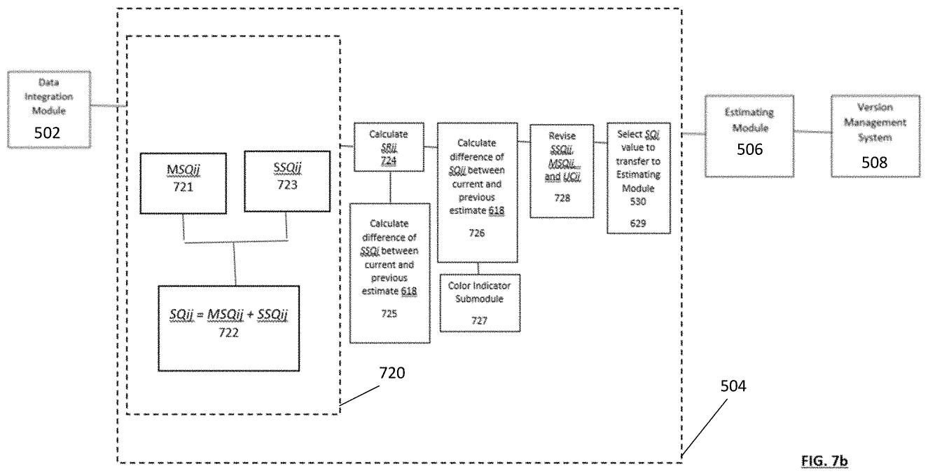

FIG. 7a depicts a detail block diagram of an embodiment of the present system. In some embodiments, a data analysis module 504 can determine Subitem Quantity (SQij) 722, Subjective Ratio (SRij) 724, a change in Subjective Subitem Quantity (SSQijΔ) 725, and a change in subitem quantity (SQijΔ) 726, which can go to a color indicator submodule 727. A data analysis module 504 can revise SSQij, MSQij, and UCij and select a SQij value to transfer to and estimating module 506.

As shown in FIG. 7b, data analytics module 504 can determine Subitem Quantity (SQij) 722 according to the formula: SQij=MSQij+SSQij 720. However, in some embodiments, alternate formulations can be used to determine Subitem Quantity.

As shown in FIG. 7c, a data analytics module 504 can determine Subjective Ratio (SRij) 520g according to the formula SRij=100*SSQij/SQij 730. However, in some embodiments, alternate formulations can be used to determine Subjective Ratio.

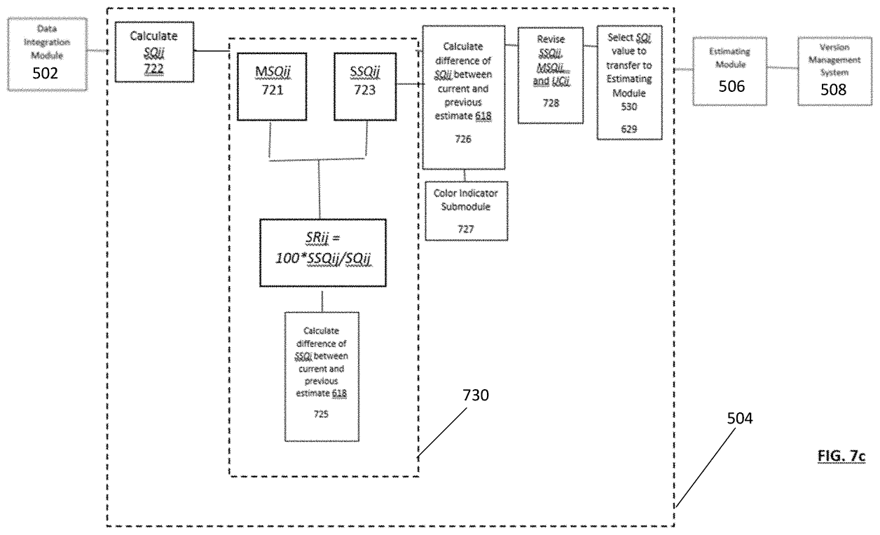

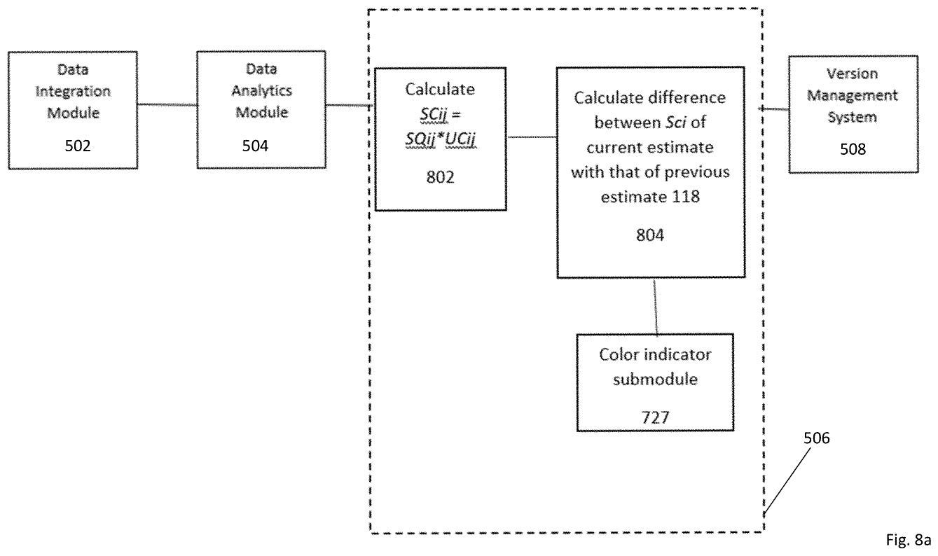

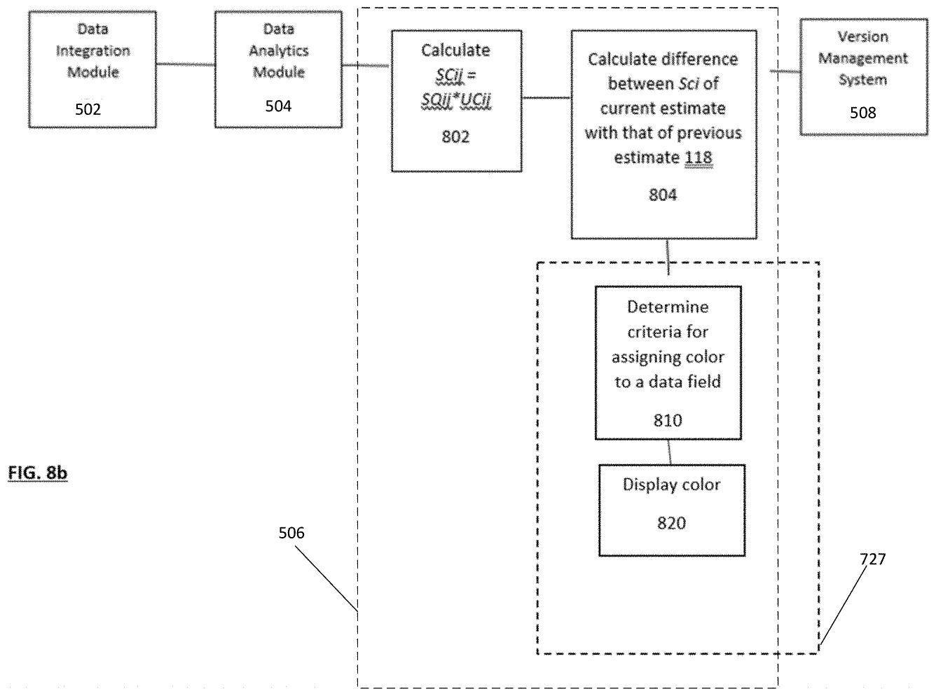

FIG. 8a depicts a detail block diagram of an embodiment of the present system. In some embodiments, an estimating module 506 can determine SCij according to the formula SCij=SQij*UCij 802. An estimating module 506 can determine the difference between SCij of a current estimate with that of a previous estimate 618 804, which can then be transferred to a color indicator submodule 727.

FIG. 8b depicts a detail block diagram of an estimating module 506 of an embodiment of the present system. In some embodiments, an estimating module 506 can determine criteria for assigning color to a data field 810 and display color 820.

Although exemplary embodiments of the invention have been described in detail and in language specific to structural features and/or methodological acts above, it is to be understood that those skilled in the art will readily appreciate that many additional modifications are possible in the exemplary embodiments without materially departing from the novel teachings and advantages of the invention. Moreover, it is to be understood that the subject matter defined in the appended claims is not necessarily limited to the specific features or acts described above. Accordingly, these and all such modifications are intended to be included within the scope of this invention construed in breadth and scope in accordance with the appended claims.

What is claimed:

1. A system for creating and modifying estimates comprising,
a data integration module, wherein said data integration module performs the steps comprising
receiving Model Subitem Quantity, Subjective Subitem Quantity, Unit Cost, and Master Estimate data;
merging said data;
organizing said data;
and storing said data;
a data analytic module, wherein said data analytic model performs the steps comprising receive said data from said data integration module;
determine subitem quantity;
determine subitem cost;
determine the change in subitem cost;
determine subitem cost ratio;
determine subjective ratio;
determine change in subjective subitem quantity;
determine subjective subitem ratio;
determine change in subitem quantity;
determine subitem quantity ratio;
an estimating module, wherein said estimating module performs the steps comprising receive subitem cost ratio, subjective ratio, subjective subitem ratio, and subitem quantity ratio;
for each ratio, determine if the ratio is less than or equal to one
if so, then accept data into master estimate
if not, determine if the ratio is less than or equal to a predetermined quantity
if so, then apply a predetermined first level of scrutiny and determine if the ratio is satisfactory
if not, then apply a predetermined second level of scrutiny and determine if the ratio is satisfactory;
if said ratios are deemed satisfactory, then accept data into the master estimate
if not, then do not accept data into the master estimate
a version management module, wherein said version management module receives Model Subitem Quantity, Subjective Subitem Quantity, and Subitem Quantity data and accepts said data into said master estimate.
